(19) United States
(12) Patent Application Publication
(10) Pub. No.: US 2016/0337868 A1
(43) Pub. Date: Nov. 17, 2016

(54) ACCESS POINT AND METHOD FOR COEXISTENCE OF WI-FI AND AIRBORNE RADARS IN THE 5 GHZ BAND

(71) Applicant: INTEL IP CORPORATION, Santa Clara, CA (US)

(72) Inventors: Thomas J. KENNEY, Portland, OR (US); Eldad PERAHIA, Portland, OR (US); Shahrnaz AZIZI, Cupertino, CA (US)

(21) Appl. No.: 15/112,904

(22) PCT Filed: Jul. 24, 2014
(86) PCT No.: PCT/US2014/048008

§ 371 Date: Jul. 20, 2016

Related U.S. Application Data
(60) Provisional application No. 61/946,154, filed on Feb. 28, 2014.

(51) Int. Cl. H04W 16/14; G01S 7/02; H04W 60/00; H04W 4/02; H04W 24/10; H04W 72/04

(52) U.S. Cl. CPC H04W 16/14; H04W 24/10; H04W 72/0446; H04W 72/0453; H04W 60/00; H04W 4/021; G01S 7/021

(57) ABSTRACT

Embodiments of an access point (AP), user device (STA), and methods for communication between APs and STAs in a wireless network are generally described herein. In some embodiments, an AP performs signal measurements to measure signal strengths of RADAR signals on a wireless communication channel in a frequency spectrum comprising 5 GHz. The AP can detect presence of RADAR signals based on the measured signal strengths. The AP can report the presence of RADAR signals on the channel to an airborne database manager, responsive to detecting RADAR signals on the channel. Other embodiments and methods are also described.

### PRIORITY APPLICATION

This application claims the benefit of priority to U.S. Provisional Patent Application No. 61/946,154, filed Feb. 28, 2014, which is incorporated herein by reference in its entirety.

### TECHNICAL FIELD

Embodiments pertain to communication networks. Some embodiments pertain to coexistence techniques for devices that operate in accordance with one of the IEEE 802.11 standards, including the IEEE 802.11n and IEEE 802.11ac standards.

### BACKGROUND

Recently, the Federal Communications Commission (FCC) has proposed modifications of the existing rules governing Unlicensed-National Information Infrastructure (U-NII) to allow shared access for U-NII devices on some sub-bands of the 5 GHz frequency band. Wi-Fi devices operating according to a standard from an IEEE 802.11 wireless standards family may expand their operating bands to take advantage of these expansion bands. However, Wi-Fi devices may need to coexist with governmental or other types of incumbent devices that may have precedence in the expansion bands.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system in which example embodiments are implemented.

FIG. 2 illustrates an example of a map where multiple access points (APs) have detected radar and the airborne database manager has declared a no-use zone in accordance with some embodiments.

FIG. 3 illustrates a flow diagram of a method to be implemented by APs wishing to use a frequency band including frequencies in the range of 5350-5470 MHz in accordance with some embodiments.

FIG. 4 is a schematic of a machine according to some embodiments.

FIG. 5 is a schematic of a wireless node according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

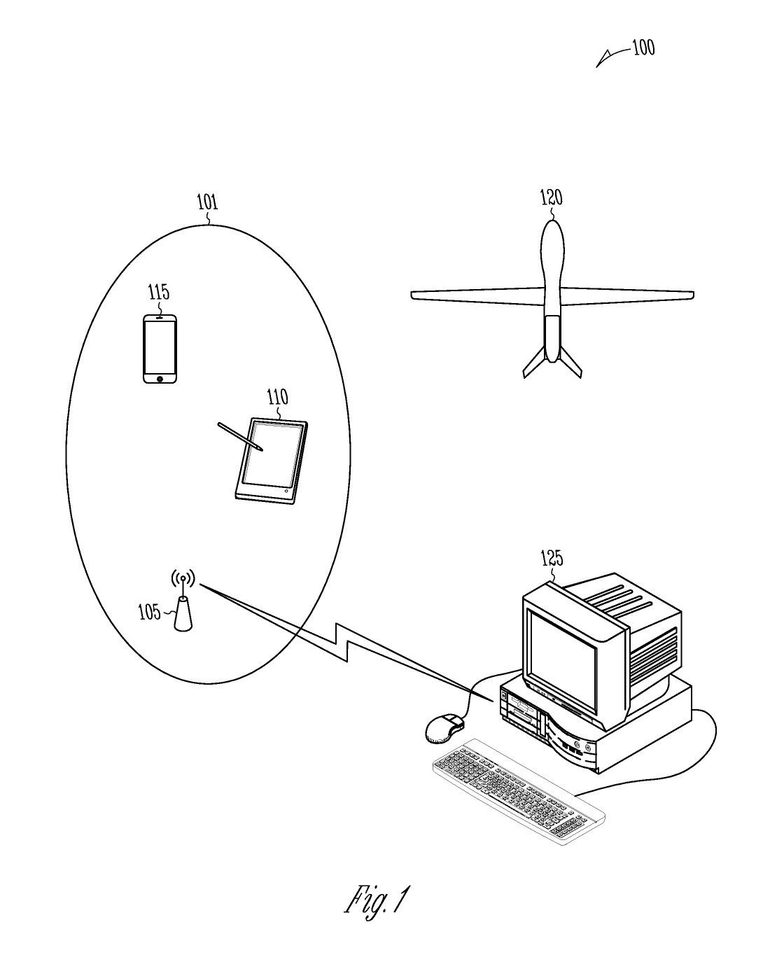

FIG. 1 illustrates a system 100 in which example embodiments can be implemented. System 100 includes an access point (AP) 105. While one AP 105 is illustrated, system 100 can included any number of APs. AP 105 can operate in accordance with a standard of the Institute of Electrical and Electronics Engineers (IEEE) 802.11 family of wireless standards including the IEEE 802.11n and the IEEE 802.11ac standards, although embodiments are not limited thereto.

System 100 includes user wireless communication stations (STAs) 110 and 115 that also operate in accordance with a standard of the IEEE 802.11 family of wireless standards including the IEEE 802.11n and the IEEE 802.11ac standards, although embodiments are not limited thereto. The STAs 110 and 115 can be, for example, laptop computers, smart phones, tablet computers, printers, or any other wireless device with or without a user interface. While only a few STAs 110 and 115 are illustrated, system 100 can include any number of STAs. STAs 110 and 115, which may also be referred to as clients, belong to a basic service set (BSS) served by the AP 105. STAs 110 and 115 may be included in a geographic region 101 within an operating range of AP 105.

Current IEEE 802.11n/ac devices such as AP 105 and STAs 110 and 115 can operate on certain sub-bands of the 5 GHz frequency band. Recently, the Federal Communications Commission (FCC) has proposed modification of the existing rules governing U-NII (Unlicensed-National Information Infrastructure) use of the 5 GHz frequency band by which 195 MHz of additional spectrum is allocated for U-NII shared access in the 5350-5470 MHz and 5850-5925 MHz sub-bands of the 5 GHz frequency band.

Embodiments are described herein with respect to the 5350-5470 MHz sub-band, although embodiments are not limited thereto. In currently available systems operating in the 5350-5470 MHz sub-band, STAs 110, 115 or AP 105 may be expected to coexist with airborne radio detection and ranging (RADAR) systems 120. Airborne RADAR systems 120 may use one or more of several waveform types and airborne RADAR systems 120 may be carried in some sort of aircraft, for example, an unmanned drone. Terrestrial-based Wi-Fi systems may interfere with airborne RADAR systems 120. As with other 5 GHz unlicensed bands, a STA 110, 115 or AP 105 should take appropriate actions to sense the media prior to use. Accordingly, embodiments provide a method by which future IEEE 802.11n/.11ac devices may operate in the 5350-5470 GHz band by coexisting with these airborne RADAR systems 120.

Current regulatory efforts are directed at quantifying the impact of Wi-Fi use in the 5350-5470 GHz band. Some regulatory findings indicate that single Wi-Fi devices do not cause significant interference to airborne RADAR systems 120. Even though the airborne RADAR systems 120 have sensitive receivers, because Wi-Fi devices are largely indoors, and because airborne RADAR systems 120 are located in aircraft separated by relatively large distances from Wi-Fi devices, single devices typically have been found to not cause significant degradation or interference to airborne RADAR systems 120. However, degradation or interference can be found in the presence of large numbers of Wi-Fi devices.

Embodiments provide a method for Wi-Fi devices to use a band, for example the 5350-5470 GHz band, when the band is not occupied by airborne RADAR systems 120 or when Wi-Fi devices are determined to be unlikely to interferer with airborne RADAR systems 120. Embodiments can create and implement a map of the airborne RADAR systems 120 in real time. Embodiments create a map identifying the location of airborne RADAR systems 120, and if an airborne RADAR system 120 is within a distance of an AP 105, as described in further detail below, then those channels are not available for use, and the AP 105 will switch STAs 110, 115 to a different channel.

In some embodiments, the map is constructed using measurements of the band provided by multiple APs (not shown in FIG. 1) in an area. An AP 105 that wishes to use the band will make measurements of the band before use. Currently available systems that use other U-NII bands may already perform such measurements. In these or other systems using other U-NII bands, APs perform measurements to detect particular signals and, if the AP detects these signals, the AP defers from using the band. However, in embodiments, APs measure the RADAR signals and further may register with an airborne database manager 125. The airborne database manager 125 may manage utilization of the airborne RADAR channels (e.g. 5350-5470 MHz). The airborne database manager 125 may permit utilization of these channels if the AP 105 has an active connection to the airborne database manager 125 and if measurements or other data indicate that the airborne RADAR channels are clear in a geographical region.

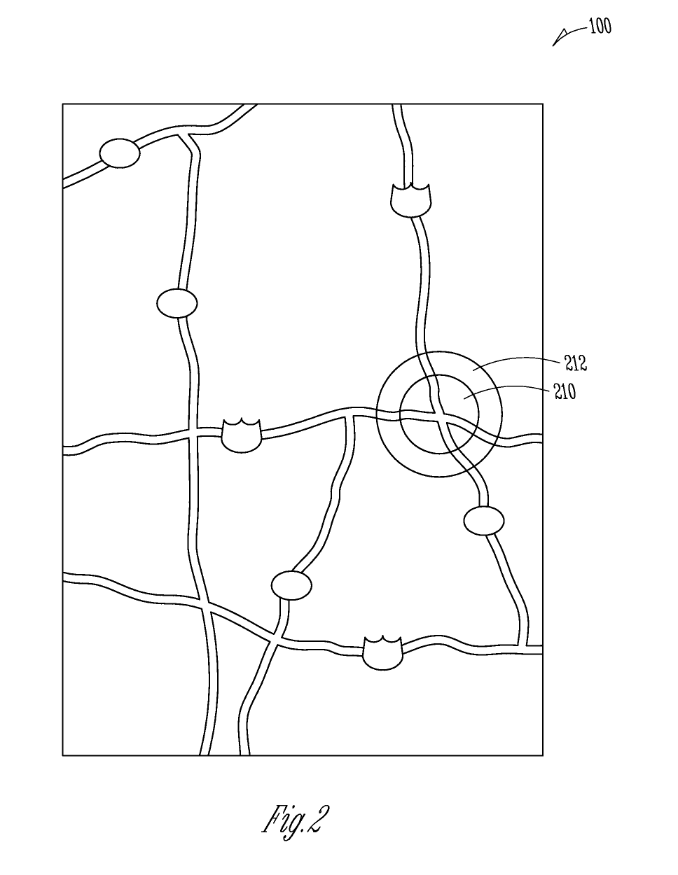

In embodiments, the AP 105 shall report any RADAR signals that the AP 105 detected, when the AP 105 first tested the channel for use, to the airborne database manager 125. The airborne database manager 125 shall record the RADAR signals and strengths thereof in memory, for example in a relational database or other type of database. The airborne database manager 125 uses the information to report to other APs (not shown in FIG. 1) that there is an airborne RADAR system 120 within the vicinity of the other APs, and that the APs are to change channels. The airborne database manager 125 may perform filtering or other operations of the received detection information from each AP, and the airborne database manager 125 perform other filtering or operations of different regions on a map such as the map 200 (FIG. 2). For example, the airborne database manager 125 may filter measurements according to the expected or historic accuracy of the corresponding AP 105 that transmitted the relevant measurement, or based on the geographic location of the corresponding AP 105 that transmitted the relevant measurement, or on any other criteria.

FIG. 2 illustrates an example of a map 200 where multiple APs have detected RADAR signals and the airborne database manager 125 has declared a no-use zone 210 in accordance with some embodiments. The airborne database manager 125 can receive measurements from multiple APs that detect the airborne RADAR systems 120 and determine, based on a threshold or other decision mechanism, when the band or a channel within the band should be cleared. For example, the airborne database manager 125 can determine whether the band should be cleared based on the number or quantity of devices, such as STAs or APs, which could potentially interfere with airborne RADAR systems 120. Based on this determination, the airborne database manager 125 can instruct at least one AP 105 to refrain from transmitting on the band. The airborne database manager 125 may control or select threshold or triggering information for determining whether the band should be cleared. The airborne database manager 125 can configure which AP locations to use for constructing the map 200.

The airborne database manager 125 may receive information concerning the size or geographical region of the no-use zone 210 of FIG. 2. The airborne database manager 125 may receive this information from governmental or regulatory agencies. A safety margin area 212 may be included around the no-use zone 210, and APs and STAs within safety margin area 212 may be restrained from transmitting in bands that may interfere with RADAR operations.

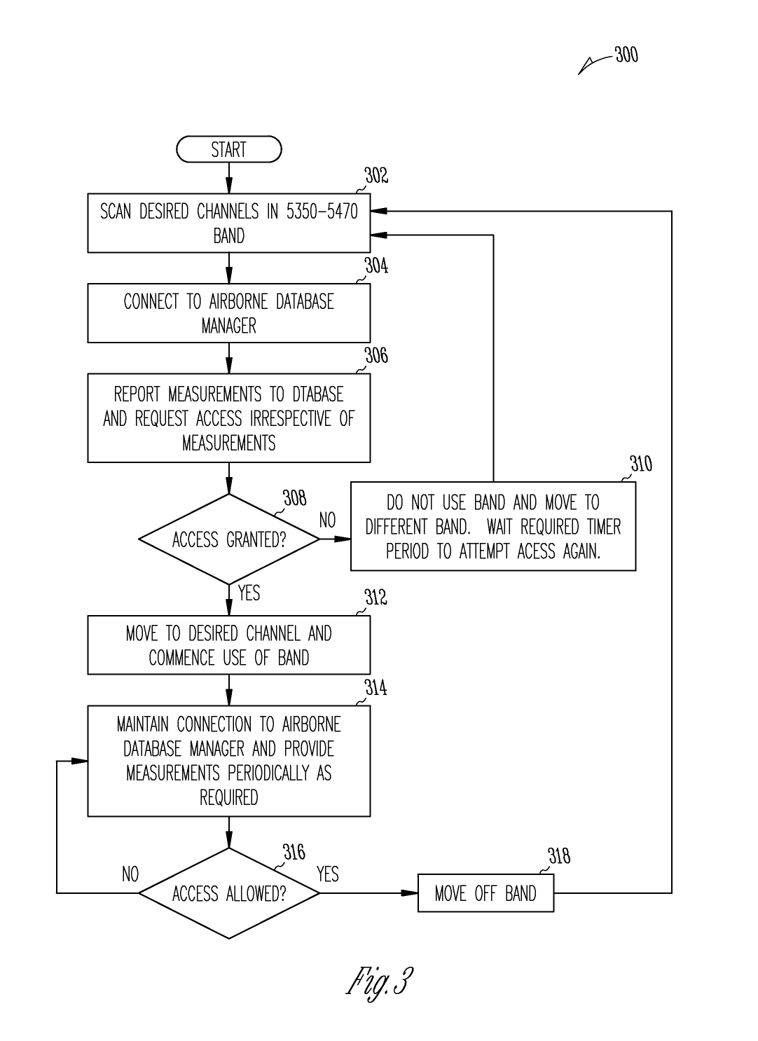

FIG. 3 illustrates a flow diagram of a method 300 to be implemented by APs wishing to use a band, for example the 5350-5470 MHz band, in accordance with some embodiments. The AP 105 (FIG. 1) can implement method 300, although a network of APs or other devices can also implement method 300.

In operation 302, the AP 105 scans desired channels in the 5350-5470 MHz band. In performing this scan, the AP 105 can performing signal measurements to measure signal strengths of the RADAR signals on the band. However, embodiments are not limited to the 5350-5470 MHz band and can include any portion of a 5 GHz band or other band. In operation 304, the AP 105 connects to the airborne database manager 125 through a registration sequence.

Example method 300 may continue at operation 306 with reporting measurements to the airborne database manager 125 and requesting access to the channel. The AP 105 may also receive reports from the airborne database manager 125 reporting the presence of RADAR signals on the channel.

Example method 300 may continue at operation 308 with determining whether the airborne database manager 125 has granted access to the channel.

If access is not granted, at operation 310, the AP 105 may refrain from using the band and move to a different channel in that band or move to a different band. AP 105 may wait a time duration, indicated by the airborne database manager 125 or stored in memory of the AP 105 or other system, before attempting access to the band again.

If access is granted, at operating 312, the AP 105 may move to the desired channel and commence use of the band.

At operation 314, the AP 105 may maintain a connection the airborne database manager 125 and provide periodic measurements of the channel. For example, the AP 105 may detect RADAR signals on the channel and report detections to the airborne database manager 125.

At operation 316, the AP 105 may periodically detect or determine whether access to the channel is allowed, based on a periodicity provided by the airborne database manager 125 or other system. If the airborne database manager 125 will not permit access, in operation 318, the AP 105 may move off band; otherwise, the AP 105 will continue to maintain connection the airborne database manager 125 and provide periodic measurements as described regarding operation 314.

In areas with dense Wi-Fi deployments, the map maintained by the airborne database manager 125 in accordance with embodiments may consist of many measurements of airborne RADAR system 120 signals, and this can provide increased levels of confidence in the detection of the airborne RADAR system 120 signals. In areas of sparse or non-dense Wi-Fi deployments, the airborne database manager 125 can be arranged to permit increased levels of Wi-Fi operation in the band because the collective power seen at the airborne RADAR system 120 may not interfere significantly with the airborne RADAR system 120.

Because the airborne database manager 125 may use detections from various APs in an area, the airborne database manager 125 can prevent a false or erroneous detection by one AP from causing the shutdown of a channel over a large area by verifying that a given report has been substantiated by other APs in the area. Further, the airborne database manager 125 can configure thresholds, filtering bandwidths, etc., based on the mission criticality of the airborne RADAR system 120 and the location of the AP's reporting. In some embodiments, if the airborne database manager 125 is aware of a mission-critical airborne RADAR system 120 in an area, the airborne database manager 125 may require any device to avoid the channel irrespective of detection levels.

Embodiments may allow the 5350-5470 MHz band to be used more extensively in most geographical regions because airborne RADAR systems 120 may not be in extensive use in most geographical regions.

Embodiments can be applied to devices operating in accordance with current versions of the IEEE 802.11 family of standards, as well as to further revisions and amendments of standards of the family of IEEE 802.11 family of standards or other standards. For example, some embodiments can be implemented on devices that implement high-efficiency WLAN (HEW) standards. HEW can address high-density deployment scenarios. HEWs may provide increased throughput in public locations such as airports and shopping malls in which high-density wireless APs serve overlapping service areas and in which user devices communicate using peer-to-peer communication mechanisms.

In accordance with some IEEE 802.11ax (HEW) embodiments, an AP may operate as a master station which may be arranged to contend for a wireless medium (e.g., during a contention period) to receive exclusive control of the medium for an HEW control period (i.e., a transmission opportunity (TXOP)). The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. During the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station may also communicate with legacy stations in accordance with legacy IEEE 802.11 communication techniques. In some embodiments, the master station may also be configurable communicate with HEW stations outside the HEW control period in accordance with legacy IEEE 802.11 communication techniques, although this is not a requirement.

In some embodiments, the links of an HEW frame may be configurable to have the same bandwidth and the bandwidth may be one of 20 MHz, 40 MHz, or 80 MHz contiguous bandwidths or an 80+80 MHz (160 MHz) non-contiguous bandwidth. In some embodiments, a 320 MHz contiguous bandwidth may be used. In some embodiments, bandwidths of 5 MHz and/or 10 MHz may also be used. In other embodiments, even smaller bandwidths of 1 MHz, 1.25 MHz and 2.5 MHz may also be used. In these embodiments, each link of an HEW frame may be configured for transmitting a number of spatial streams.

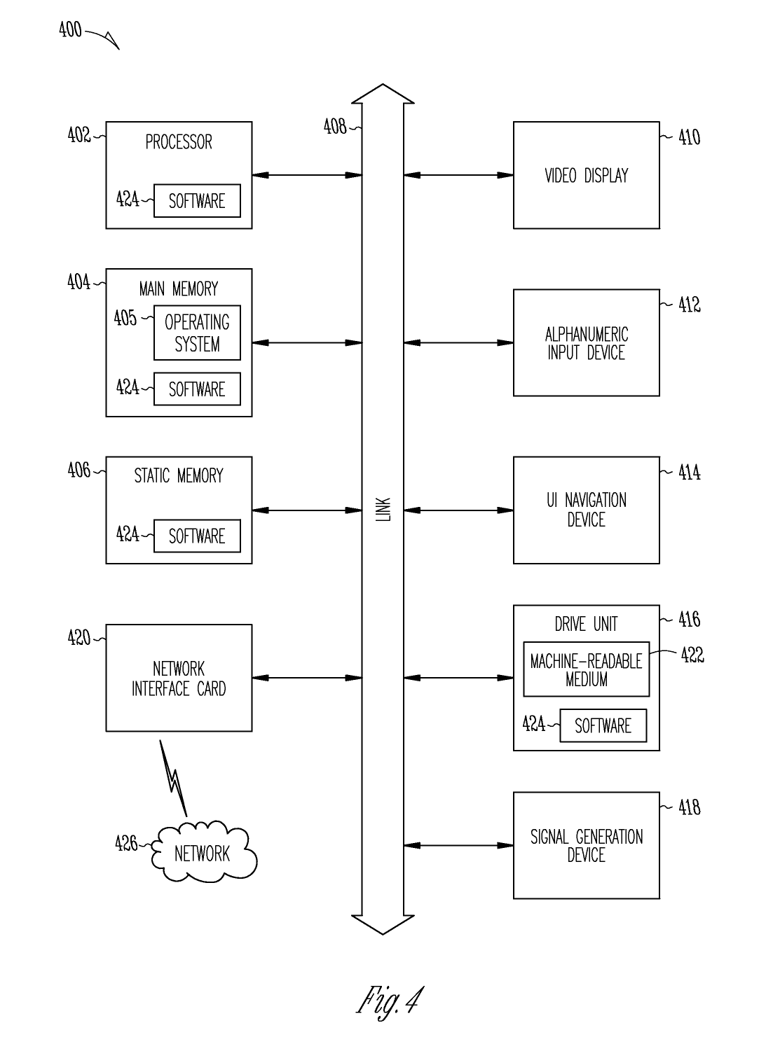

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, an Access Point (AP), a Station (STA), or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. When the machine 400 operates as an airborne database manager 125 (FIG. 1), the processor 402 may generate and maintain a map. As described earlier herein, the map will be based at least in part on measurement information, received from APs, that represents or corresponds to RADAR signal strength in or within a range of the pertinent geographic region corresponding to the map. For example, the map can include the geographic locations of airborne RADAR systems based on the measurements. In at least these embodiments, the processor 402 can determine whether APs (FIG. 1) that have registered with the airborne database manager 125 may transmit on a band based on location information of the APs and based on the map. For example, as described earlier herein, the processor 402 can instruct at least one AP to refrain from transmitting on a wireless communication channel including frequencies in the range of 5350-5470 MHz responsive to determining that the signal strengths of the RADAR signals exceed a threshold. The processor 402 can select the threshold based on how many user devices are within the geographic region, or on how many user devices are operating in the geographic region on the wireless communication channel including frequencies in the range of 5350-5470 MHz. For example, if only a few devices are within a range of the RADAR systems, these devices may be allowed to operate in the band because the collective power that could be generated by the devices and seen at the RADAR would not be expected to interfere with the RADAR.

As described earlier herein, the processor 402 can perform a filtering operation, based on the measurements received from the APs, to generate the map. In at least these embodiments, the main memory 404 or static memory 406 or other memory can store a RADAR database for populating the map. The main memory 404 or static memory 406 can also store information from other systems, such as systems operated by governmental agencies, related to RADAR systems.

When the machine 400 operates as an AP 105 (FIG. 1), the processor 402 may perform signal measurements to measure signal strengths of RADAR signals on a wireless communication channel in a frequency spectrum comprising 5 GHz. The processor 402 may detect presence of RADAR signals based on the measured signal strengths. The processor 402 can perform a registration sequence to register with the airborne database manager 125.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor.

When the machine operates as an airborne database manager 125, the network interface device 420 can receive reports from APs that a RADAR has been detected within a vicinity of the corresponding AP, when the machine 400 operates to serve roles of an airborne database manager 125 (FIG. 1). In at least these embodiments, the network interface device 420 can transmit the reports to APs that have registered with the airborne database manager 125.

When the machine 400 operates as an AP 105, the network interface device 420 can report the presence of RADAR signals on the channel to an airborne database manager, responsive to the processor 402 detecting the RADAR signals on the channel. The network interface device 420 can receive reports from the airborne database manager 125 reporting the presence of RADAR signals on the wireless communication channel, so that the processor 402 can suppress transmissions on the wireless communication channel for at least a time duration based on reports received from the airborne database manager 125.

The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media. The storage device 416 can also store map information or other information for tracking or maintaining RADAR system databases.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400, and includes digital or analog communications signals or other intangible medium to facilitate communication of such software.

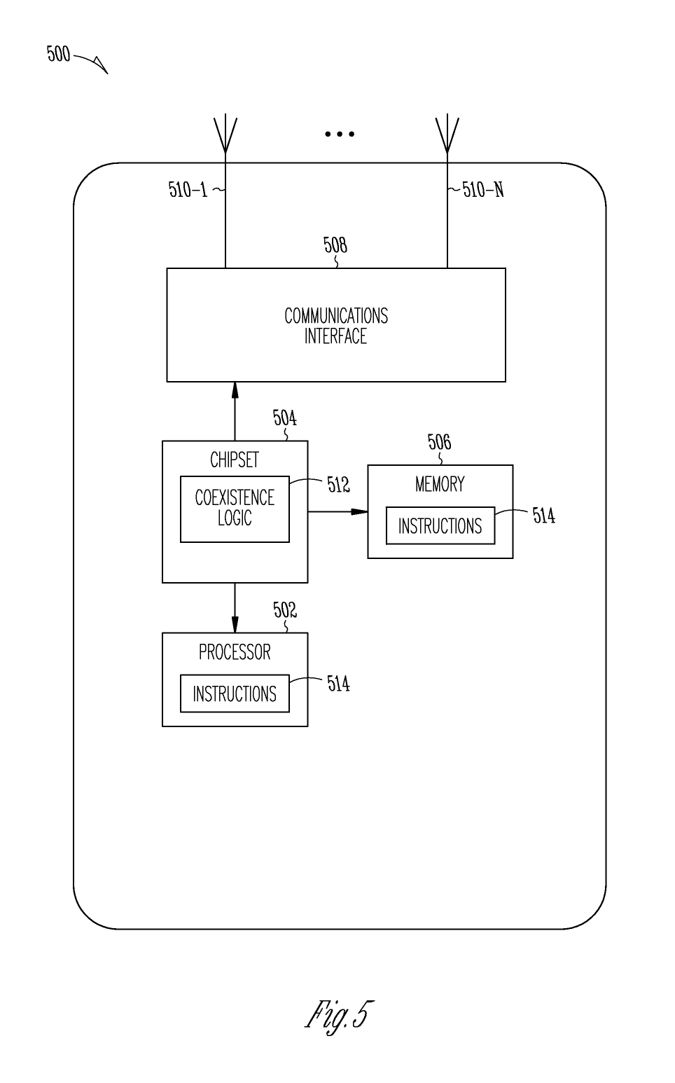

FIG. 5 illustrates a functional block diagram of a node 500, in accordance with some embodiments. Node 500 may be suitable as a STA 110 (FIG. 1) or as an AP 105 (FIG. 1). Node 500 supports methods for operating in a wireless communication network, in accordance with embodiments. Node 500 may communicate in accordance with a standard of the IEEE 802.11n family of standards or with a standard of the IEEE 802.11ac family of standards or amendments or future versions thereof.

Node 500 can include a processor 502, which uses a chipset 504 to access on-chip state memory 506, as well as a communications interface 508. In one embodiment memory 506 includes, but is not limited to, random access memory (RAM), dynamic RAM (DRAM), static RAM (SRAM), synchronous DRAM (SDRAM), double data rate (DDR) SDRAM (DDR-SDRAM), or any device capable of supporting high-speed buffering of data.

In at least one embodiment, communications interface 508 is, for example, a wireless Physical Layer (PHY), which operates according to a multiple input/multiple output (MIMO) operation. Communications interface 508 receives a signal at least on a wireless communication channel in the 5 GHz band. For example, communications interface 508 can receive a signal in a frequency range from about 5.85 GHz to 5.925 GHz or from about 5.35 GHz to 5.47 GHz. Communications interface 508 transmits messages to report the presence of RADAR signals on the channel to the airborne database manager 125 (FIG. 1), in situations in which the processor 502 detects RADAR signals on the channel.

Chipset 504 may incorporate therein coexistence logic 512 to, for example, perform signal measurements of a wireless communication channel in a frequency spectrum comprising 5 GHz and report RADAR signals to a system in a RADAR reporting message. The system can include an airborne database manager 125 (FIG. 1). In an embodiment, chipset 506 provides MAC layer functionality.

Embodiments may be implemented in one or a combination of hardware, firmware, and software. Embodiments may also be implemented as instructions 514 stored on a non-transitory computer-readable storage device, which may be read and executed by at least one processor 502 to perform the operations described herein.

Processor 502 can measure signal strengths of RADAR signals on a wireless communication channel in a frequency spectrum comprising frequencies in the range of 5350-540 MHz. The processor 502 can detect presence of RADAR signals based on the measured signal strengths. Processor 502 can register with the system (e.g., airborne database manager 125) and receive reports of RADAR signals from the system. Processor 502 can suppress transmissions on the band based on reports received from the system. If Node 500 operates as STA 110, processor 502 can receive a signal from an AP 105 indicating that an airborne RADAR system 120 (FIG. 1) is detected on a band, and refrain from transmitting on the band responsive to receiving the signal.

In some embodiments, instructions 514 are stored on processor 502 or memory 506 such that processor 502 and memory 506 act as computer-readable media. A computer-readable storage device can include any non-transitory mechanism for storing information in a form readable by a machine (e.g., a computer). For example, a computer-readable storage device may include ROM, RAM, magnetic disk storage media, optical storage media, flash-memory devices, and other storage devices and media.

Instructions 514, when executed on Node 500, may cause Node 500 to perform any of the operations described herein. For example, instructions 514 may cause Node 500 to perform operations including performing signal measurements to measure signal strengths of RADAR signals on a wireless communication channel in a frequency spectrum comprising 5 GHz; detecting presence of RADAR signals based on the measured signal strengths; and reporting the presence of RADAR signals on the channel to an airborne database manager, responsive to detecting RADAR signals on the channel.

Although Node 500 is illustrated as having several separate functional elements, one or more of the functional elements may be combined and may be implemented by combinations of software-configured elements, such as processing elements including digital signal processors (DSPs) and/or other hardware elements. For example, some elements may comprise one or more microprocessors, DSPs, application specific integrated circuits (ASICs), radio-frequency integrated circuits (RFICs), and combinations of various hardware and logic circuitry for performing at least the functions described herein. In some embodiments, the functional elements of Node 500 may refer to one or more processes operating on one or more processing elements.

Node 500 may include multiple transmit and receive antennas 510-1 through 510-N, where N is a natural number. Antennas 510-1 through 510-N may comprise one or more directional or omnidirectional antennas, including, for example, dipole antennas, monopole antennas, patch antennas, loop antennas, micro strip antennas, or other types of antennas suitable for transmission of RF signals. In some embodiments, instead of two or more antennas, a single antenna with multiple apertures may be used. In these embodiments, each aperture may be considered a separate antenna. In some MIMO embodiments, antennas 510-1 through 510-N may be effectively separated to take advantage of spatial diversity and the different channel characteristics that may result between each of antennas 510-1 through 510-N. In some MIMO embodiments, antennas 510-1 through 510-N may be separated by up to 1/10 of a wavelength or more. In some embodiments, antennas 510-1 through 510-N may include bandpass filters or other filtering circuitry to filter a received signal into various subchannels with different bandwidths, for example 1 MHz, 2 MHz, 5 MHz, 10 MHz, 20 MHz, or other bandwidths.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### Additional Notes & Examples

Example 1 may include subject matter (such as a device, apparatus, wireless communication (STA), access point (AP), client or system) including processing circuitry to measure signal strengths of RADAR signals on a wireless communication channel in a frequency spectrum comprising frequencies in the range of 5350-540 MHz and to detect presence of the RADAR signals based on the measured signal strengths, and physical layer (PHY) circuitry to transmit a message to report the presence of the RADAR signals on the channel to an airborne database manager, responsive to the one or more processors detecting the RADAR signals on the channel.

Example 2 may optionally include the subject matter of Example 1, wherein the processing circuitry is further arranged to perform a registration sequence to register with the airborne database manager, and wherein the PHY circuitry is further arranged to receive reports from the airborne database manager reporting the presence of RADAR signals on the wireless communication channel.

Example 3 may optionally include the subject matter of Examples 1-2, wherein the processing circuitry is further arranged to suppress transmissions on the wireless communication channel based on reports received from the airborne database manager for at least a time duration indicated by the airborne database manager.

Example 4 may optionally include the subject matter of Examples 1-3, wherein the AP serves as a High-Efficiency WLAN (HEW) master station.

Example 5 may include subject matter (such as a device, apparatus, user station (STA), client or system) including physical layer (PHY) circuitry to receive instructions from a serving access point (AP) to suppress transmissions on a wireless communication channel in a frequency spectrum comprising frequencies in the range of 5350-5470 MHz.

Example 6 may optionally include the subject matter of claim 5, wherein the instructions further indicate a time duration after which the STA is permitted to transmit on the wireless communication channel in a frequency spectrum comprising frequencies in the range of 5350-5470 MHz.

Example 7 may optionally include the subject matter of claim 5, wherein the PHY circuitry is further arranged to receive measurements of signal strengths of RADAR signals from a neighboring STA or a neighboring AP; and forward the measurements to the serving AP.

Example 8 may include subject matter (such as a device, apparatus, access point (AP), client or system) including one or more processors arranged to perform signal measurements to measure signal strengths of RADAR signals on a wireless communication channel in a frequency spectrum comprising 5 GHz, and detect presence of the RADAR signals based on the measured signal strengths; physical layer circuitry to report the presence of the RADAR signals on the channel to an airborne database manager, responsive to the one or more processors detecting the RADAR signals on the channel; and one or more antennas coupled to the physical layer circuitry.

Example 9 may optionally include the subject matter of Example 8, and further including data storage to store map information or other information received from the airborne database manager.

Example 10 may optionally include the subject matter of Example 8, wherein the one or more processors are further arranged to perform a registration sequence to register with the airborne database manager; and wherein physical layer circuitry is further arrange to receive reports from the airborne database manager reporting the presence of RADAR signals on the wireless communication channel, such that the one or more processors suppress transmissions on the wireless communication channel for at least a time duration based on reports received from the airborne database manager.

Example 11 may include subject matter (such as means for performing acts or machine readable medium including instructions that, when executed by an access point (AP) cause the AP to perform acts including performing signal measurements to measure signal strengths of RADAR signals on a wireless communication channel in a frequency spectrum comprising 5 GHz, detecting presence of the RADAR signals based on the measured signal strengths, and reporting the presence of the RADAR signals on the channel to an airborne database manager, responsive to detecting the RADAR signals on the channel.

Example 12 may optionally include the subject matter of Example 11, wherein the wireless communication channel includes frequencies in the range of 5350-5470 MHz.

Example 13 may optionally include the subject matter of Examples 11-12, further comprising instructions to perform a registration sequence to register with the airborne database manager; and receive reports from the airborne database manager reporting the presence of RADAR signals on the wireless communication channel.

Example 14 may optionally include the subject matter of Examples 11-12, further comprising instructions to suppress transmissions on the wireless communication channel based on reports received from the airborne database manager for at least a time duration indicated by the airborne database manager.

Example 15 may include subject matter (such as a device, apparatus, access point (AP), client, computer, or system) comprising communication circuitry to receive measurements of signal strengths of RADAR signals from a wireless communication access point (AP); one or more processors to generate a map of geographic locations of airborne RADAR systems based on the measurements; and memory to store the map and measurements of signal strengths of RADAR signals.

Example 16 may optionally include subject matter of Example 15, wherein the communication circuitry is arranged to receive measurements from a plurality of APs, and the one or more processors are arranged to perform a filtering operation, based on the measurements received from the plurality of APs, to generate the map.

Example 17 may optionally include subject matter of Examples 15-16, wherein the one or more processors are further arranged to instruct at least one AP of the plurality of APs to refrain from transmitting on a wireless communication channel including frequencies in the range of 5350-5470 MHz responsive to determining that the signal strengths of the RADAR signals exceed a threshold.

Example 18 may optionally include subject matter of Examples 15-17, wherein the one or more processors are arranged to select the threshold based on a number of user devices in the geographic region that are operating on the wireless communication channel including frequencies in the range of 5350-5470 MHz.

Example 19 may optionally include the subject matter of Examples 15-17, wherein the one or more processors are arranged to select a size of geographic region for which transmissions are to be limited on the wireless communication channel based on information received from a second system.

Example 20 may optionally include subject matter of Examples 15-16, wherein the one or more processors are further arranged to determine that a report of RADAR signal detection, received from an AP of the plurality of APs, is a false report based on contradictory reports of other APs of the plurality of APs, and instruct the plurality of APs that use of a wireless communication channel including frequencies in the range of 5350-5470 MHz is permitted responsive to determining that the report of RADAR signal detection is false.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1-20. (canceled)

21. An access point (AP) for operating in a wireless communication network, the AP comprising:
processing circuitry to:
measure signal strengths of RADAR signals on a wireless communication channel in a frequency spectrum comprising frequencies in the range of 5350-540 MHz, and
detect presence of the RADAR signals based on the measured signal strengths; and physical layer (PHY) circuitry to
transmit a message to report the presence of the RADAR signals on the channel to an airborne database manager, responsive to the one or more processors detecting the RADAR signals on the channel.

22. The AP of claim 21, wherein the processing circuitry is further arranged to perform a registration sequence to register with the airborne database manager, and wherein the PHY circuitry is further arranged to receive reports from the airborne database manager reporting the presence of RADAR signals on the wireless communication channel.

23. The AP of claim 22, wherein the processing circuitry is further arranged to suppress transmissions on the wireless communication channel based on reports received from the airborne database manager for at least a time duration indicated by the airborne database manager.

24. The AP of claim 21, wherein the AP serves as a High-Efficiency WLAN (HEW) master station.

25. A wireless communication station (STA) for operating in a wireless communication network, the STA comprising:
physical layer (PHY) circuitry to receive instructions from a serving access point (AP) to suppress transmissions on a wireless communication channel in a frequency spectrum comprising frequencies in the range of 5350-5470 MHz.

26. The STA of claim 25, wherein the instructions further indicate a time duration after which the STA is permitted to transmit on the wireless communication channel in a frequency spectrum comprising frequencies in the range of 5350-5470 MHz.

27. The STA of claim 25, wherein the PHY circuitry is further arranged to
receive measurements of signal strengths of RADAR signals from a neighboring STA or a neighboring AP; and
forward the measurements to the serving AP.

28. A system comprising:
one or more processors arranged to
perform signal measurements to measure signal strengths of RADAR signals on a wireless communication channel in a frequency spectrum comprising 5 GHz, and
detect presence of the RADAR signals based on the measured signal strengths; physical layer circuitry to report the presence of the RADAR signals on the channel to an airborne database manager, responsive to the one or more processors detecting the RADAR signals on the channel; and
one or more antennas coupled to the physical layer circuitry.

29. The system of claim 28, further including data storage to store map information or other information received from the airborne database manager.

30. The system of claim 28, wherein the one or more processors are further arranged to perform a registration sequence to register with the airborne database manager; and wherein physical layer circuitry is further arrange to receive reports from the airborne database manager reporting the presence of RADAR signals on the wireless communication channel, such that the one or more processors suppress transmissions on the wireless communication channel for at least a time duration based on reports received from the airborne database manager.

31. A non-transitory computer-readable storage medium that stores instructions for execution by one or more processors to perform operations to configure an access point to:
perform signal measurements to measure signal strengths of RADAR signals on a wireless communication channel in a frequency spectrum comprising 5 GHz;
detect presence of the RADAR signals based on the measured signal strengths; and
report the presence of the RADAR signals on the channel to an airborne database manager, responsive to detecting the RADAR signals on the channel.

32. The non-transitory computer-readable storage medium of claim 31, wherein the wireless communication channel includes frequencies in the range of 5350-5470 MHz.

33. The non-transitory computer-readable storage medium of claim 32, further comprising instructions to:
perform a registration sequence to register with the airborne database manager; and
receive reports from the airborne database manager reporting the presence of RADAR signals on the wireless communication channel.

34. The non-transitory computer-readable storage medium of claim 32, further comprising instructions to:
suppress transmissions on the wireless communication channel based on reports received from the airborne database manager for at least a time duration indicated by the airborne database manager.

35. A system comprising:
communication circuitry to
receive measurements of signal strengths of RADAR signals from a wireless communication access point (AP);
one or more processors to
generate a map of geographic locations of airborne RADAR systems based on the measurements; and
memory to store the map and measurements of signal strengths of RADAR signals.

36. The system of claim 35, wherein
the communication circuitry is arranged to receive measurements of signal strengths of RADAR signals from a plurality of APs, and
the one or more processors are arranged to perform a filtering operation, based on the measurements received from the plurality of APs, to generate the map.

37. The system of claim 36, wherein the one or more processors are further arranged to:
determine that a report of RADAR signal detection, received from an AP of the plurality of APs, is a false report based on contradictory reports of other APs of the plurality of APs, and
instruct the plurality of APs that use of a wireless communication channel including frequencies in the range of 5350-5470 MHz is permitted responsive to determining that the report of RADAR signal detection is false.

38. The system of claim 36, wherein the one or more processors are arranged to:
instruct at least one AP of the plurality of APs to refrain from transmitting on a wireless communication channel including frequencies in the range of 5350-5470 MHz responsive to determining that the signal strengths of the RADAR signals exceed a threshold.

39. The system of claim 38, wherein the one or more processors are arranged to select the threshold based on a number of user devices in the geographic region that are operating on the wireless communication channel including frequencies in the range of 5350-5470 MHz.

40. The system of claim 38, wherein the one or more processors are arranged to select a size of geographic region for which transmissions are to be limited on the wireless communication channel based on information received from a second system.
